(19) United States
(12) Patent Application Publication
(10) Pub. No.: US 2022/0166140 A1
(43) Pub. Date: May 26, 2022

(54) PERIODIC LINEAR ARRAY WITH UNIFORMLY DISTRIBUTED ANTENNAS

(71) Applicants: SHIH-YUAN YEH, TAINAN CITY (TW); YING-HSUAN WU, TAINAN CITY (TW)

(72) Inventor: Shih-Yuan YEH, TAINAN CITY (TW)

(21) Appl. No.: 17/105,163

(22) Filed: Nov. 25, 2020

(51) Int. Cl. H01Q 3/38; H01Q 21/10; H01Q 3/26

(52) U.S. Cl. CPC H01Q 3/38; H01Q 3/2617; H01Q 21/10

(57) ABSTRACT

An antenna array may be provided. The antenna array comprises N radiating elements and M phase shifters, where M is less than N. N may be an integer greater than or equal to three. M may be an integer greater than or equal to two. The N radiating elements may be arranged linearly. Two adjacent radiating elements may be separated substantially by an integer multiple of a first spacing. The N radiating elements may be grouped into a first number of groups, wherein each of the groups comprises at least one and at most M adjacent radiating elements. The N radiating elements may be connected to the M phase shifters in such a way that: one radiating element is connected to at most one phase shifter; and two sequential radiating elements connected to the same phase shifter are separated by a second spacing, the second spacing being substantially an integer multiple of M multiplied by the first spacing.

### TECHNICAL FIELD

This disclosure generally relates to antenna arrays. Embodiments of the present disclosure can be applicable to phased antenna arrays and phased-array beamforming.

Particular embodiments of the present disclosure relate to uniformly distributed linear arrays for switched-beam radiation systems.

### BACKGROUND

A phased array system comprises an antenna array that is made up of individual or subarrays of radiating elements. The generated radiation pattern has a shape and direction which is determined by the relative phases and amplitudes of the currents at the individual radiating elements. The relative phases of the outputs from the individual radiating elements are varied to electronically steer the beam. The more radiating elements there are in the array, the higher the possible maximum gain that the array can achieve, provided that the phases of the radiating elements are controlled.

To electronically steer the beam, the phases of the radiating elements are adjusted by phase shifters, which in turn are controlled by one or more steering circuits. The phased array system may also include other modules or sub-systems such as transmit/receive (TR) modules and beamforming networks (BFNs). Hence, the system complexity and cost are generally proportional to the size of the antenna array, which determines the number of radiating elements, and related circuitry.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

### SUMMARY

One way to increase the achievable gain of an antenna array is to use more radiating elements. A higher gain can be achieved if all radiating elements of the array can be so controlled as to generate constructive interference from their respective signals.

Constructive interference can be generated by carefully controlling the phase of the signal to and/or from each of the radiating elements. One conventional method of phase control is to provide a phase shifter or a phase corrector for each of the radiating elements in the array. However, phase shifters can be expensive, and the complexity of the system for controlling each of the phase shifters can grow rapidly as the number of phase shifters increases.

Therefore, one objective of the subject matter in the present disclosure is to provide apparatuses, systems and methods that can realize the high-gain benefit of antenna arrays at a reduced cost and limited system complexity.

Another objective of the subject matter in the present disclosure is to enable the control of a plurality of radiating elements in an array without the need for a phase adjustment component for each of the radiating elements. A large number of radiating elements can be controlled by a reduced number of phase adjustment components; at the same time, an increased gain can still be achieved.

According to an aspect of the present disclosure, a radiation-processing array is provided. The radiation-processing array comprises N radiating elements and M phase shifters, where M is less than N. N is an integer that may be greater than or equal to three, and M is an integer that may be greater than or equal to two and less than N. The N radiating elements may be arranged linearly. The N radiating elements may be substantially equally spaced. The N radiating elements may be divided into a first plurality of groups of adjacent radiating elements. The groups may comprise different numbers of radiating elements. In an embodiment, all but one of the first plurality of groups comprise M radiating elements. Each of the M phase shifters may be connected to a respective radiating element in each of the groups, such that a distance between two sequential radiating elements connected to the same phase shifter is substantially identical. Each of the N radiating elements may be connected to at most one phase shifter.

Since the radiating elements may be substantially equally spaced, the phase relationship among them can be known. This information can be exploited to control the phases of the radiating elements with fewer phase shifters, and the switching angles of the array (i.e., the beamforming angles, at which a local maximum gain can be achieved) can be calculated. Moreover, since the distance (and therefore phase) relationship between the radiating elements connected to the same phase shifter is also known, and since each of the radiating elements may be connected to at most one phase shifter, the number of phase shifters needed is less than that of the radiating elements, thereby reducing the system cost and complexity.

That is, fewer phase shifters are needed because structural information in the phase delays among the radiating elements is extracted and exploited. In other words, the subject matter of the present disclosure fully takes advantage of the periodicity in the (relative) phase delays of the radiating elements.

In an embodiment, all of the first plurality of groups may comprise M radiating elements. That is, all the groups may comprise the same number of radiating elements. The symmetry across all groups can help further boost the array gain.

In an embodiment, the one group that does not comprise M radiating elements may be arranged after the other groups, and may comprise fewer than M radiating elements. That is, the number of radiating elements is not restricted to an integer multiple of the number of phase shifters. This can increase the system design flexibility.

In an embodiment, the radiating elements may comprise at least one of electromagnetic-wave radiating elements and mechanical-wave radiating elements. Because the subject matter of the present disclosure exploits the structure in the phase information of waves, it is therefore independent of the physical phenomena that generate the wave. All kinds of wave radiating elements are suitable.

In an embodiment, the radiating elements may comprise antennas or sonar devices. Antenna arrays according to the subject matter of the present disclosure are especially useful, as mobile communication technology has been deeply integrated into modern life. Applying the subject matter of the present disclosure to sonar is also advantageous because long-range usage is common, and therefore each dB of available gain would be appreciated.

In an embodiment, each of the N radiating elements may comprise a phase center, and the phase centers of the N radiating elements may form a substantially straight line. In an embodiment, a distance between the phase centers of two adjacent radiating elements may be substantially identical for all adjacent radiating elements. The more regular the spatial relationship among the radiating elements is, the more information can be extracted to facilitate the control of the array.

According to an aspect of the present disclosure, an antenna array may be provided. The antenna array comprises N radiating elements and M phase shifters, where M is less than N. N may be an integer greater than or equal to three. M may be an integer greater than or equal to two. The N radiating elements may be arranged linearly. Two adjacent radiating elements may be separated substantially by an integer multiple of a first spacing. The N radiating elements may be grouped into a first number of groups, wherein each of the groups comprises at least one and at most M adjacent radiating elements. The N radiating elements may be connected to the M phase shifters in such a way that: one radiating element is connected to at most one phase shifter; and two sequential radiating elements connected to the same phase shifter are separated by a second spacing, the second spacing being substantially an integer multiple of M multiplied by the first spacing.

Understanding the spatial relationship between the radiating elements facilitates the identification and exploitation of the phase relationship therebetween, while the flexible number of radiating elements in any particular group increases design flexibility. Again, fewer phase shifters than radiating elements are used. A known spacing relationship between the radiating elements connected to the same phase shifter further facilitates the control of the antenna array and the beamforming operation.

In an embodiment, the first number may be the ceiling function of N divided by M. In this way, the radiating elements may be closely grouped together, reducing the physical size of the resulting antenna array. Also, the number of groups is reduced, facilitating their control.

In an embodiment, a beamforming angle of the antenna array may satisfy the equation of

$$- 1 \leq \frac{ξ \cdot π}{β \cdot M \cdot d \cdot {180}^{°}} = sin {θ}_{s} \leq 1 ,$$

where ξ is an integer multiplied by 360 degrees, d is the first spacing, and β is the phase constant of the medium in which radiation to or from the antenna array propagates. That is, the subject matter of the present disclosure may enable a large degree of design freedom by specifying the relationship between available beamforming angles, the number of phase shifters (which is one factor associated with system costs), and the first spacing (which is a factor associated with the physical size of the array). A system designer may, for example, start from the constraints of overall budget and system form factor consideration, and then work out possible beamforming angles. The system designer may also, for example, start from performance requirements of beamforming angles and associated gain magnitude, and then figure out the required system component counts and size.

In an embodiment, a path length from at least one radiating element to a respective phase shifter may be substantially identical to or may be an integer multiple of a wavelength at an operating frequency. In an embodiment, for each of the N radiating elements, the path length from the radiating element to the respective phase shifter may be substantially identical to or may be an integer multiple of the wavelength at the operating frequency. These may increase the level of constructive interference, and thus, total gain amount.

According to an aspect of the present disclosure, an antenna array may be provided. The antenna array comprises at least three linearly arranged radiating elements; at least two phase shifters, where a number of the phase shifters is less than a number of the radiating elements; and at least two dividers. The number of the dividers may be the same as the number of the phase shifters. Each of the dividers may comprise an input port and a plurality of output ports. Each of the phase shifters is connected to the input port of a respective divider. The radiating elements may be divided into a plurality of groups of adjacent radiating elements. Each group may comprise at most the same number of radiating elements as the number of the phase shifters. The output ports of each of the dividers is connected to at most one respective radiating element in each of the groups in such a way that for each of the radiating elements connected to the same divider, sufficiently or substantially similar phase progressions occur between an output of the phase shifter and the radiating elements.

Since signals are subject to sufficiently or substantially similar phase changes between phase shifters and radiating elements that generate constructive interference, the performance of the antenna array improves.

In an embodiment, a magnitude of a difference between the phase progressions that occur between the output of the phase shifter and each of the radiating elements connected to the same divider may be less than about 22.5 degrees. In other embodiments, the difference may be less than about 15 degrees, or about 10 degrees, or about 5 degrees, or about 2 degrees, or about 1 degree. The smaller the difference, the more constructive the interference is.

According to an aspect of the present disclosure, a method for operating a wave-generation array may be provided. The wave-generation array comprises a first plurality of linearly arranged radiating elements and a second plurality less which is than the first plurality of phase shifters. The first plurality may be at least three and the second plurality may be at least two. The method may comprise arranging the first plurality of radiating elements into a third plurality of groups of neighboring radiating elements. The method may comprise connecting each of the second plurality of phase shifters to at most one radiating element in each group, such that the steering phase of a radiating element is substantially identical to the steering phase of other radiating elements connected to the same phase shifter.

In an embodiment, a magnitude of a difference between the steering phase of the radiating elements connected to the same phase shifter may be less than 22.5 degrees. In other embodiments, the difference may be less than about 15 degrees, or about 10 degrees, or about 5 degrees, or about 2 degrees, or about 1 degree. The smaller the difference, the more constructive the interference is.

In an embodiment, the method may comprise pointing the wave-generation array at a switching angle θₛ, wherein θₛ satisfies the equation of

$$- 1 \leq \frac{ξ \cdot π}{β \cdot M \cdot d \cdot {180}^{°}} = sin {θ}_{s} \leq 1 ,$$

where ξ is an integer multiplied by 360 degrees, β is the phase constant of free space, and M is the second plurality.

Any of the aspects and embodiments of the subject matter of the present disclosure may be incorporated into applications such as mobile communication devices, mobile base stations, radar and sonar devices. The application to mobile communication devices may be especially advantageous because such devices may face a more stringent limit to the device cost, size and complexity. The application to mobile base stations may also be especially advantageous because the base stations may be equipped with a large number of radiating elements.

Any of the aspects and embodiments of the subject matter of the present disclosure may be practiced individually or in any combination, unless otherwise explicitly stated.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates an incident wave-front arriving at an antenna array, in accordance with some embodiments of the present disclosure.

FIG. 2 illustrates a phased array system, in accordance with some embodiments of the present disclosure.

FIG. 3 illustrates the front view of an antenna array, in accordance with an embodiment of the present disclosure.

FIG. 4 illustrates a VSWR plot showing an impedance match to a 50-ohm feed at 2.4 GHz for a sample design of a patch antenna, in accordance with an embodiment of the present disclosure.

FIG. 5 illustrates an E-plane radiation pattern of a patch antenna, which may be a radiating element of an antenna array in accordance with an embodiment of the present disclosure.

FIG. 6 illustrates an H-plane radiation pattern of a patch antenna, which may be a radiating element of an antenna array in accordance with an embodiment of the present disclosure.

FIGS. 7, 7-1, 7-2, 7-3 and 7-4 illustrate radiation patterns of an exemplary antenna array at designated switching angles (θₛ), in accordance with an embodiment of the present disclosure.

FIG. 8 illustrates the front view of an antenna array, in accordance with an embodiment of the present disclosure.

FIGS. 9, 9-1, 9-2, 9-3 and 9-4 illustrate radiation patterns of an exemplary antenna array at designated switching angles (θₛ), in accordance with an embodiment of the present disclosure.

FIGS. 10, 11A and 11B illustrate exemplary configurations of a phased array, in accordance with some embodiments of the present disclosure.

FIG. 12 illustrates a spherical coordinate system.

### DETAILED DESCRIPTION OF THE DISCLOSURE

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in various examples. This repetition is for simplicity and clarity and does not in itself dictate a relationship between the various embodiments and/or configurations discussed.

Phased arrays make use of constructive interference of waves from multiple radiating elements to boost gain to a level that cannot be achieved by individual radiating elements. To generate constructive interference, the phase relationship between the signals fed to the radiating elements is controlled.

Conventional phased arrays employ at least one phase adjustment component (such as a phase shifter or a phase corrector) for each radiating element in the array. Although this enables fine control of the individual radiating elements, the resulting system complexity and cost are usually prohibitively high. As such, the application of phased arrays has conventionally been limited to less cost-sensitive applications, such as military-grade radar.

Conventionally, the design and operation of phased arrays started from the perspective of transmission. The amount of phase shift provided by each of the phase shifters is set. That is, a phase shift is imposed on each radiating element, and then the beamforming or switching angles of the array and the associated gain can be calculated.

In contrast, the inventor approaches the design problem from the perspective of reception. He assumes an incoming wave, and then examines the phase of each radiating element (e.g., antennas).

The inventor recognizes that an incoming wave generates a specific phase relationship at certain sets of locations. From there, he can figure out the phase relationship of a phased array if the radiating elements are placed at the sets of locations that will generate an outgoing wave that achieves a certain level of gain at certain beamforming angles. The phase relationship has a certain structure that can obviate the need for at least one phase shifter for each radiating element. That is, fewer phase shifters may be used to control a larger number of radiating elements while simultaneously using beamforming.

The details will be further described below, with reference to the accompanying drawings.

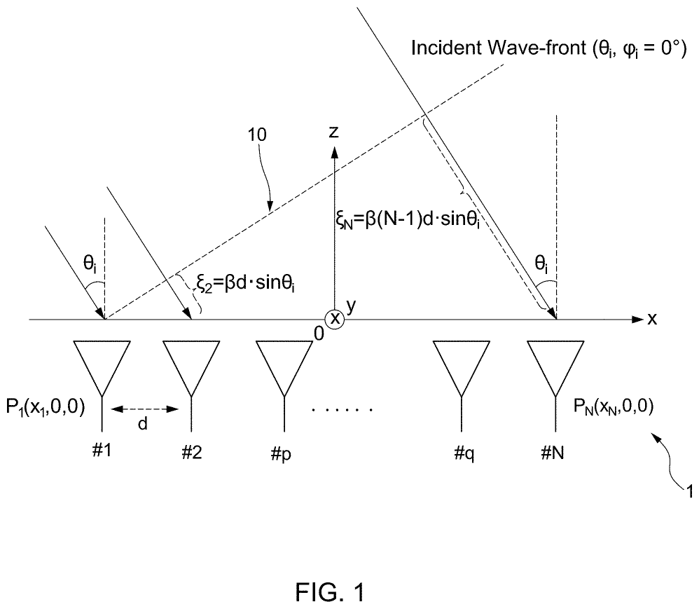

FIG. 1 illustrates an incident wave-front 10 arriving at an antenna array 1, in accordance with some embodiments of the present disclosure.

The antenna array 1 includes N radiating elements. The radiating elements are separated from each other and may be arranged linearly. The radiating elements may be uniformly spaced, although this is not a limitation to the subject matter of the present disclosure (as will become clear later). In the embodiment of FIG. 1, the radiating elements are uniformly spaced, and the amount of spacing is denoted as d.

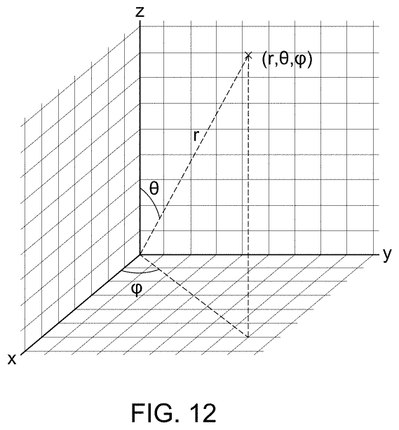

In the present disclosure, both the Cartesian coordinates (x, y, z) and the spherical coordinates (r, θ, φ) are employed. These coordinates are well known in the art. Referring to FIG. 12, regarding the spherical coordinates (r, θ, φ) notation in the present disclosure, θ refers to the polar angle from the positive z-axis and φ refers to the azimuth angle. That is, a line connecting the origin and the point (r, θ, φ) forms an angle θ with the positive z-axis; and φ is the angle formed between the positive x-axis and the projection of said line onto the xy-plane.

In the embodiment of FIG. 1, the radiating elements #1, #2 . . . #N are arranged along the x-axis. Their locations are indicated as (x₁, 0, 0), (x₂, 0, 0) . . . (x_{N}, 0, 0), respectively. The incident wave-front 10 is at an incident angle θᵢ. For simplicity, the azimuthal incident angle φᵢ is assumed to be zero, although the same principle applies to non-zero azimuthal angles. In an embodiment, the location of a radiating element is specified as its phase center, but other definitions of the location of radiating elements are also possible so long as they are applied consistently across all radiating elements in the array.

As the incident wave-front 10 arrives, it creates progressive phase delays along the radiating elements. The amount of the progressive phase delay (ξ_{N} for the N^{th} radiating element) is proportional to the distance between the wave-front 10 and the location of the radiating element (x_{N},0,0). Specifically, the progressive phase delay for the N^{th} radiating element in the uniformly spaced linear array 1 is ξ_{N}=β*(N−1)*d*sin θᵢ*180°/π, where β is the phase constant of the medium (which may be free space) in which the wave-front 10 propagates, d is the spacing and θᵢ is the incident angle (between the ray and the array broadside in this example). Applying a phase conjugate of ξ_{N} yields the phase of the wave transmitted by the antenna array toward the direction (θᵢ) from which the incident wave arrives.

For a uniformly distributed linear array, the phase difference ξ_{σ} between radiating elements p and q is expressed as:

$${•ξ}_{σ} = {ξ}_{p} - {ξ}_{q} = β ( q - p ) d \cdot sin {θ}_{i} \cdot \frac{{180}^{°}}{π} \qquad ( 1 )$$

That is, the phase difference ξ_{σ} between two radiating elements p and q in the array vary according to the incident angle θᵢ. If the incident angle θᵢ is such that ξ_{σ} is equal to 0° or integer multiples of ±360°, then such an incident angle would make radiating elements p and q have the same phase. Thus, if the phase difference ξ_{σ} between the radiating elements p and q is zero (or an integer multiple of ±360°), then it is possible that the radiating elements p and q share the same phase-shifting device. That is, it is possible to connect one phase shifter to more than one radiating element.

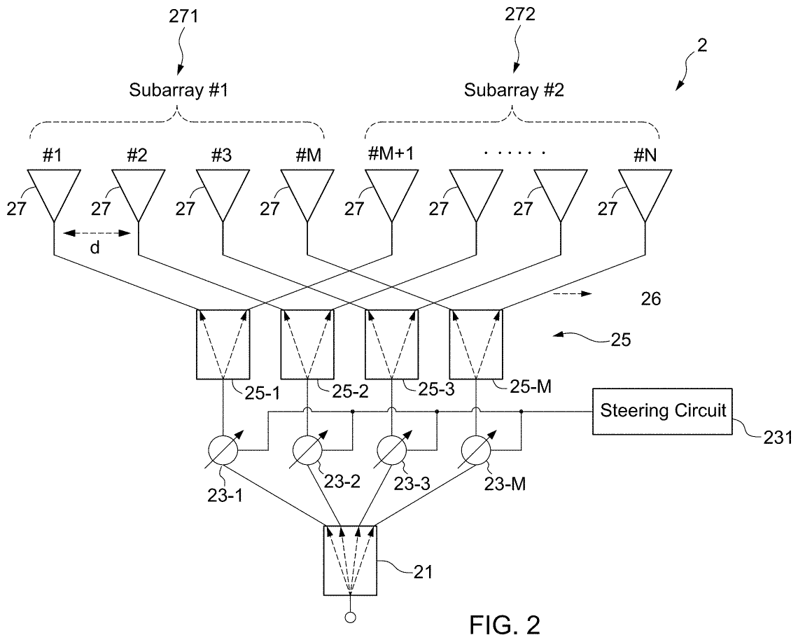

Refer to FIG. 2, which illustrates a phased array system 2 in accordance with some embodiments of the present disclosure.

The phased array system 2 includes a first stage power distribution network, which may include a divider 21, M phase shifters 23-1, 23-2 . . . 23-M, a steering circuit 231 that controls the phases shifters, a second stage power distribution network 25, which may include M dividers 25-1, 25-2 . . . 25-M, a feeding network 26, and N radiating elements 27 grouped into several subarrays 271, 272.

In the embodiment illustrated in FIG. 2, N equals to 8 and M equals to 4. However, these numbers are exemplary and do not limit the present disclosure. Also, M is less than N, which causes at least some of the phase shifters to be connected to more than one radiating element. In some embodiments, N is greater than or equal to three. In some embodiments, M is greater than or equal to two.

The divider 21 may be regarded as the input of the phased array system 2 and receiver signals that will eventually be radiated by the radiating elements 27. The divider 21 may be a power divider and may receive electric signals, which can be converted by the radiating elements 27 into electromagnetic waves to be radiated out. The divider 21 may divide its input signal into several signals. In an embodiment, the divider 21 may divide its input signal into several signals with substantially equal power. The divider 21 may also divide its input signals to make the output signals have substantially identical phases. The divider 21 may include one input port and at least one output port.

The phase shifters 23-1, 23-2 . . . 23-M may adjust the phase of the signals that are passing. The phase shifters 23-1, 23-2 . . . 23-M may be implemented as electric and/or microwave circuitry. The steering circuit 231 may individually or collectively control the amount of phase shift that the phase shifters 23-1, 23-2 . . . 23-M apply to the signals.

The second stage power distribution network 25 directs the signals output from the phase shifters 23-1, 23-2 . . . 23-M to the radiating elements 27 by way of the feeding network 26. Since there are fewer phase shifters than radiating elements, the second stage power distribution network 25 may include dividers 25-1, 25-2 . . . 25-M, which may be power dividers. These power dividers may divide their input signals into several output signals with substantially equal power (amplitude and phase). Each of the dividers in the second stage power distribution network 25 may include one input port and at least one output port.

The radiating elements 27 may be grouped into subarrays 271, 272. Although the subarrays 271, 272 have the same number of radiating elements 27, this is not a limitation to the present disclosure, and some subarrays may have a different number of radiating elements from other subarrays. Each of the subarrays 271, 272 may have M radiating elements 27 (where M is 4 in the example illustrated in FIG. 2). In the example of FIG. 2, the radiating elements 27 are linearly arranged with a uniform spacing d.

An array of N linearly arranged radiating elements with uniform spacing d is grouped into subarrays of M adjacent radiating elements. In the context of the present disclosure, two radiating elements are “adjacent” if there are no intervening radiating elements.

For example, radiating elements #1 and #2 are adjacent to each other, but radiating elements #1 and #3 are not.

The first M radiating elements (e.g., #1, #2 . . . #M) are grouped into the first subarray 271, and the next M radiating elements (e.g., #M+1, #M+2 #M+M) are grouped into the second subarray 272, and so on. In some embodiments, N is not an integer multiple of M, in which case, fewer than M radiating elements (i.e., the remainder of N divided by M) will be grouped into the last subarray. Radiating elements #1 and #(M+1) may be referred to as the first radiating elements in each subarray; similarly, radiating elements #2 and #(M+2) may be referred to as the second radiating elements in each subarray.

Equation (1) describes the phase difference between two radiating elements with respect to an incoming wave-front at the incident angle θᵢ. If the phase difference between two radiating elements is zero (or an integer multiple of ±360°), then the two radiating elements can share the same phase shifter. This will be explained in more detail below, with reference to the phased array system 2 illustrated in FIG. 2.

Solely for simplicity of illustration, assume that a signal being fed into the divider 21 is divided into signals with substantially equal phase and amplitude (and hence power).

The signals at the input of the phase shifters 23-1, 23-2 . . . 23-M then have substantially the same phase and amplitude.

Starting with the observation from equation (1), when the phased array system 2 is operated in the transmitting mode at a main-beam switching angle θₛ, the phase difference between radiating elements p and q where q−p=M is

$${ξ}_{σ}^{*} = β \cdot M \cdot d \cdot sin {θ}_{s} \cdot \frac{{180}^{°}}{π} \qquad ( 2 )$$

where the main-beam switching angle θₛ is measured between the radiating main beam and the array broadside. At the switching angle(s) θₛ which satisfies equation (2) where ξ_{σ}* is 0 degrees or an integer multiple of 360 degrees, the phased array system 2 can achieve a peak gain, and the radiating elements with corresponding positions in each of the subarrays (such as #1 and #M+1, #2 and #M+2, etc.) can radiate (and receive) waves with construct interference, because of the substantially equal phases. Note that the absolute value of the sine term in equation (2) also has to be less than or equal to one:

$$- 1 \leq \frac{{ξ}_{σ}^{*} \cdot π}{β \cdot M \cdot d \cdot {180}^{°}} = sin {θ}_{s} \leq 1 \qquad ( 3 )$$

In other words, given a phased array system 2 with known system parameters such as the spacing between radiating elements d (which may be constrained by form factor) and the number of phase shifters (which may be constrained by cost, complexity and form factor), the switching or beamforming angles θₛ can be solved with the help of equations (2) and (3). The number of solution for θₛ indicates the number of beamforming angles that the phased array system 2 can achieve with a limited number of phase shifters. Note that a higher array gain can be achieved by repeating the radiating element subarrays (i.e., increasing N) at these beamforming angles with the same number of phase shifters (i.e., fixing M), so long as the same phase shifter is connected to the radiating elements in each subarray with the same corresponding location. Also note that the array has the same switching/beamforming angles for transmitting and receiving waves.

In some embodiments, instead of evaluating all possible ξ_{σ}*, we may consider only the switching angles θₛ within the field-of-view (FOV) of the phased array. In an embodiment where a planar array is concerned, the FOV is usually greater than or equal to −90° and less than or equal to 90° for both azimuth and elevation planes. Since β, M, and d in equation (3) may be parameters, their product may be represented by a constant γ. Afterwards, equation (3) is transformed to

$$- {90}^{°} <= {θ}_{s} = {sin}^{- 1} ( \frac{{ξ}_{σ}^{*} \cdot π}{γ \cdot {180}^{°}} ) <= {90}^{°} \qquad ( 4 )$$

A few observations can be made from equation (4). First, the angle 0° is always a solution for θₛ. Second, more solutions in the FOV become available as γ increases. This means that methods to increase the number of available beamforming angles include using more phase shifters (increasing M), operating the array at a higher frequency (increasing β), and using a wider spacing (increasing d).

In some embodiments, the second stage power distribution network 25 and the feeding network 26 provide substantially the same path length for each path between the phase shifters 23-1, 23-2 . . . 23-M and the radiating elements 27, or provide path lengths such that the difference between two paths is an integer multiple of the guided wavelength (λ_{g}) at the operating frequency; the term “guided” refers to the fact that the wavelength being considered here is the wavelength in a non-free-space medium, such as a coaxial cable and a waveguide. Path lengths with substantially no difference or with differences that are integer multiples of the operating wavelengths can increase the level of constructive interference, sometime referred to as “radiating elements that are in-phase.” The higher the level of constructive interference, the sharper the gain peak may be at the beamforming angles.

In some embodiments, each of the radiating elements 27 is connected to at most one phase shifter. This can simplify the phase control system and algorithm and reduce overall system cost. This simplification is enabled by the inventor's appreciation of the phase relationship between radiating elements separated at specific distances when the phased array is operating at the switching/beamforming angles.

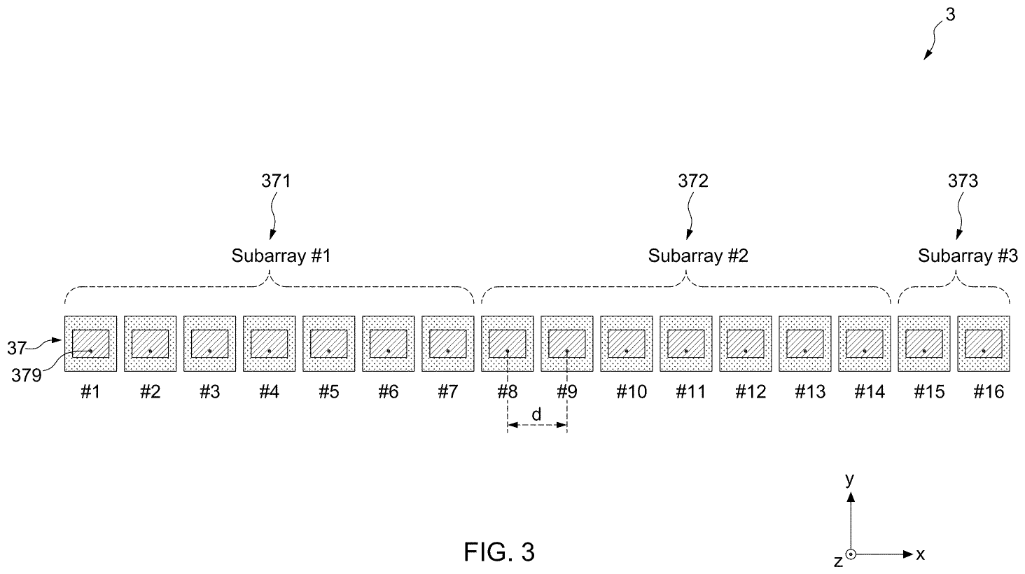

Refer to FIG. 3, which illustrates an antenna array 3 including N=16 microstrip patch antennas as the radiating elements 37. FIG. 3 may be viewed as a more practical implementation of the subject matter of the present disclosure. For simplicity, only the radiating elements 37 of the antenna array 3 are illustrated in FIG. 3; other elements, such as phase shifters and power distribution networks, are not shown in FIG. 3.

To examine the operating characteristics of the antenna array 3, the array performance is evaluated by beamforming the main beam at each individual switching angle (θₛ) with unity (or equal) amplitude solved from equation (4). The evaluation is done in an electromagnetic simulator with an operating frequency at 2.4 GHz.

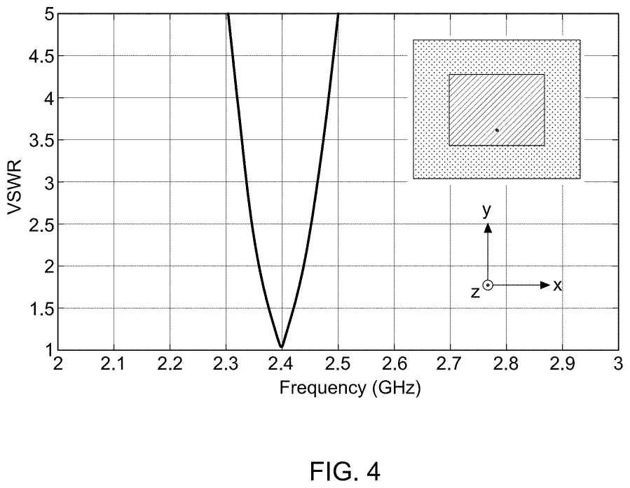

As indicated in FIG. 3, the antenna array 3 is uniformly distributed with an equal spacing of d=62.5 mm, which is equal to 0.5λ (half of the free space wavelength) at 2.4 GHz. The microstrip patch antennas 37 are linearly-polarized (y-polarized; as shown in FIG. 4) and are arranged in the xy-plane. The patch antennas 37 have been designed to have an input impedance of approximately 50Ω at 2.4 GHz, and are modeled on a 62-mil-thick (1.57 mm) FR4 (εᵣ=4.4) substrate, which has a width of 54 mm and a length of 58 mm. The patch antennas 37 have a width of w=38 mm and a resonant length of L=28.8 mm, and the probe is fed at a distance of 6.5 mm from the patch edge.

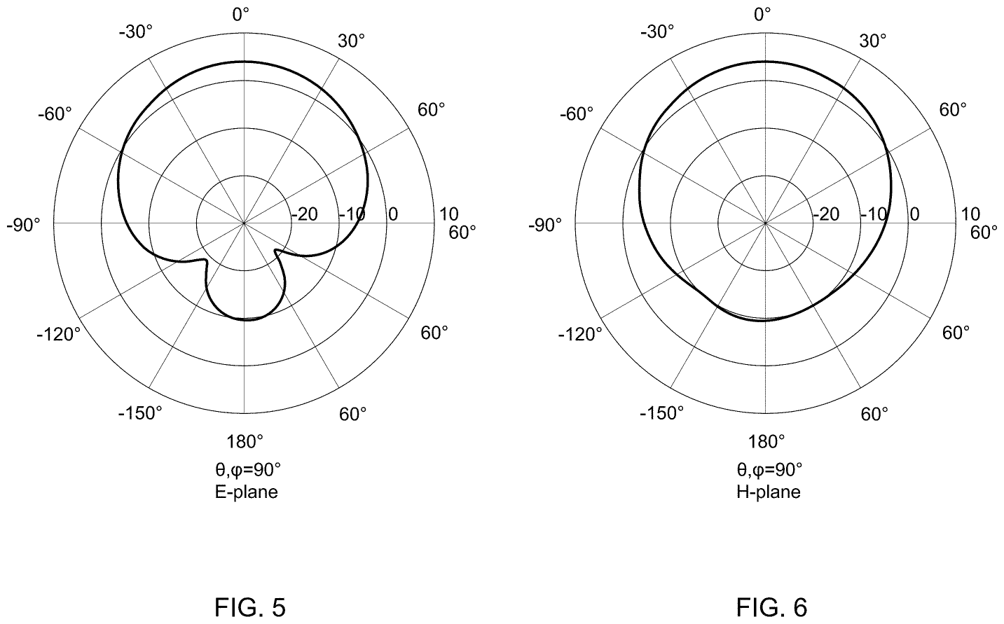

FIG. 4 shows an exemplary VSWR of the patch antenna from 2 GHz to 3 GHz. FIGS. 5 and 6 indicate the radiation patterns of the patch antenna in both E- and H-planes at 2.4 GHz, and the maximum gain is 4.12 dBi at (θ, ϕ)=(0°, 0°).

Refer back to FIG. 3. In this example, seven phase shifters (not shown in FIG. 3 for simplicity) are connected to the radiating elements 37, along with other components such as the feeding network and power distribution networks. Note that M=7 in the example of FIG. 3, and the first two subarrays 371, 372 both have M=7 radiating elements. The subarray 373 has two radiating elements, where the number two is the remainder of N (16) divided by M (7). Note that in this example, the number of subarrays is the ceiling function of N (16) divided by M (7), that is, 3.

The phase shifters are connected to the radiating elements 37 such that the first phase shifter is connected to radiating elements #1, #8 and #15, the second phase shifter is connected to radiating elements #2, #9 and #16; the third phase shifter is connected to radiating elements #3 and #10, and so on. The array FOV is set from −90°≤θₓ≤90° and ϕₛ=0°. From the array configuration and based on equations (2), (3) and (4) and noting that λ is (3*10⁸)/(2.4*10⁹)=0.125 (m), β is (2π/λ)=about 50.625 (rad/m), d is 0.0625 (m) and M is 7, solutions for θₛ exist at ±58.99°, ±34.85°, ±16.60°, and 0°. That is, there are seven switching angles available in the FOV.

In the present disclosure, radiating elements connected to the same phase shifter may be referred to as “sequential” radiating elements, even though they are not necessarily adjacent to each other. For example, radiating elements #1, #8 and #15 are all connected to the first phase shifter, and thus radiating elements #1 and #8 may be referred to as “sequential” radiating elements. Similarly, radiating elements #8 and #15 may also be referred to as “sequential” radiating elements. Similarly, radiating elements #8 and #15 may also be referred to as “sequential” radiating elements.

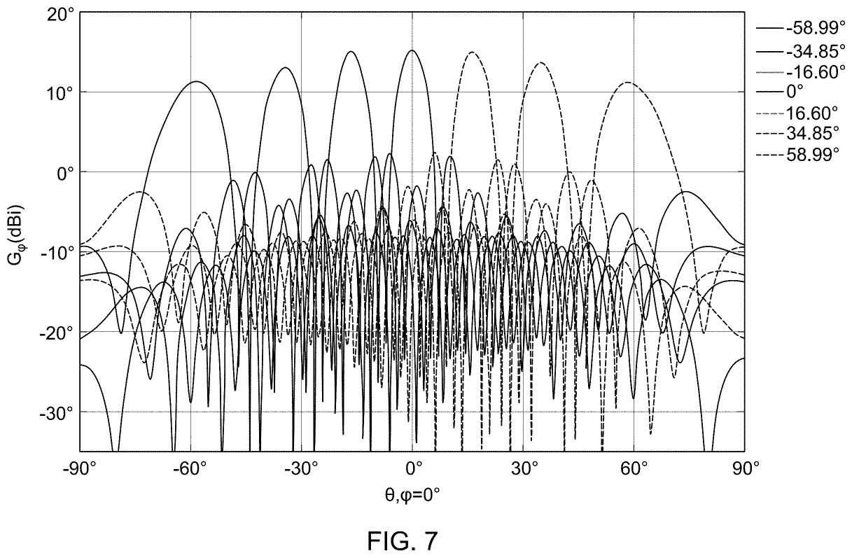

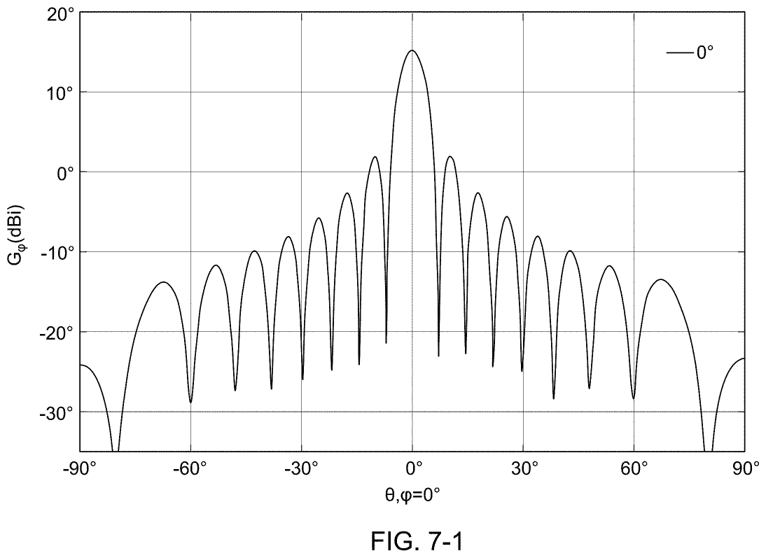

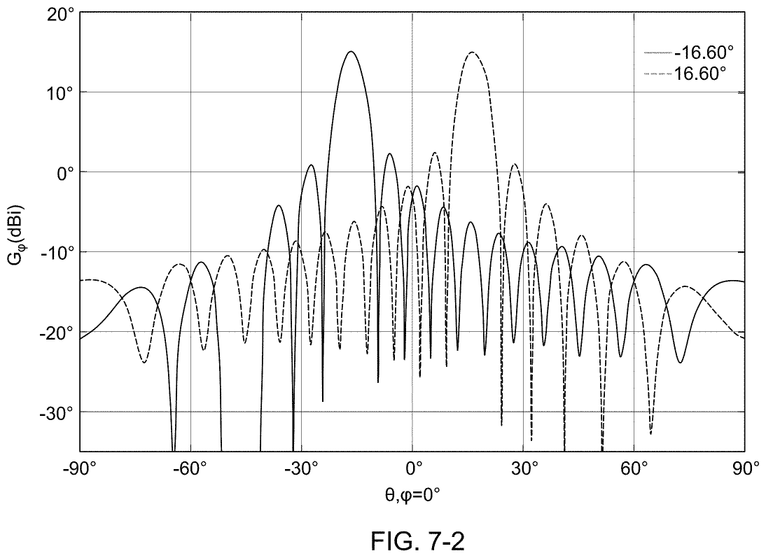

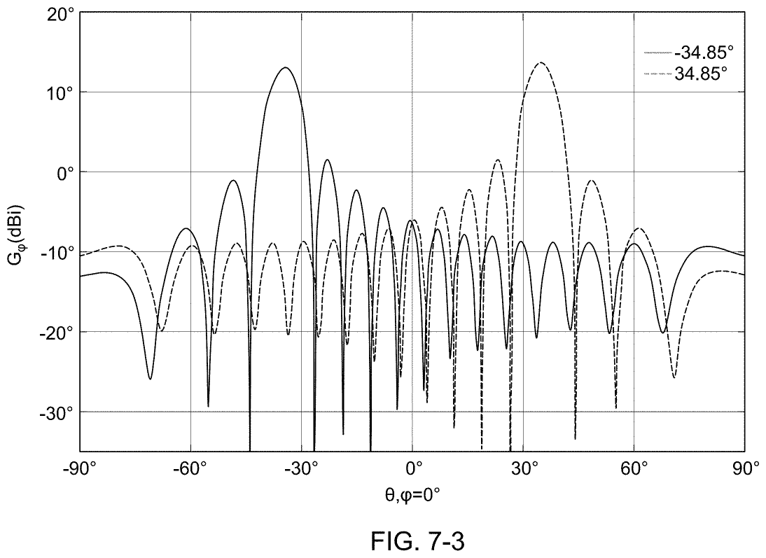

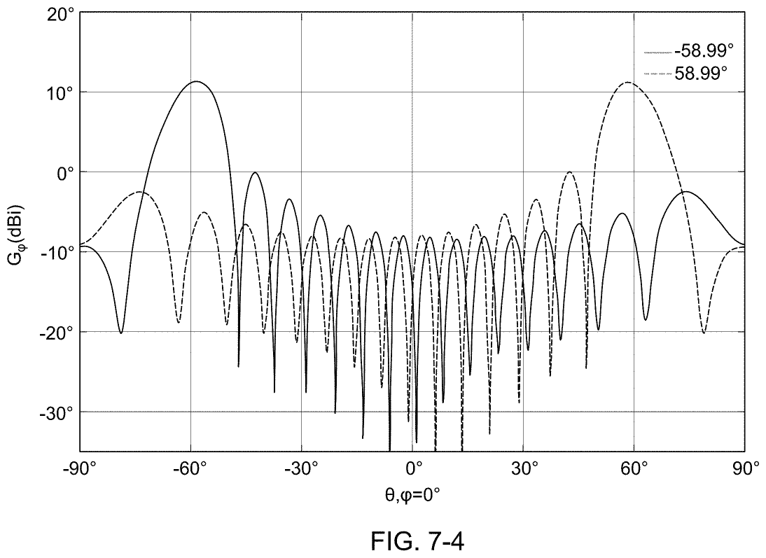

FIG. 7 illustrates exemplary radiation patterns at the seven solutions for θₛ, according to an embodiment of the present disclosure. The procedures for beamforming to these angles are based on S. Yeh, Z. Chen and Y. Wu, “Developing Circular-Polarized Beamforming Techniques on Volumetric Random Arrays with Arbitrarily Oriented Array Elements,” 2019 International Symposium on Antennas and Propagation (ISAP), Xi'an, China, 2019, pp. 1-3, which is incorporated by reference in its entirety. For clarity, FIGS. 7-1 to 7-4 are also provided, each illustrating exemplary radiation patterns at one or two of the seven solutions for θₛ. FIGS. 7-1 to 7-4 illustrate the exemplary radiation patterns at 0°, ±16.60°, ±34.85° and ±58.99°, respectively.

FIG. 7 demonstrates that peak gains can be achieved at the solutions for θₛ. Table I includes the steering phase of each radiating element when the array is beamformed at the seven angles θₛ:

| Antenna Number | Switching Angles (θₛ) | | | | | | |
|---|---|---|---|---|---|---|---|
| (#N) | −58.99° | −34.85° | −16.60° | 0° | 16.60° | 34.85° | 58.99° |
| 1 | −77.14° | −51.43° | −25.71° | 0° | 25.71° | 51.43° | 77.14° |
| 2 | −282.86° | −308.57° | −334.28° | 0° | 334.28° | 308.57° | 282.86° |
| 3 | −128.57° | −205.71° | −282.86° | 0° | 282.86° | 205.71° | 128.57° |
| 4 | −334.29° | −102.86° | −231.43° | 0° | 231.43° | 102.86° | 334.29° |
| 5 | −180° | −360° | −180° | 0° | 180° | 360° | 180° |
| 6 | −25.71° | −257.14° | −128.57° | 0° | 128.57° | 257.14° | 25.71° |
| 7 | −231.43° | −154.29° | −77.14° | 0° | 77.14° | 154.29° | 231.43° |
| 8 | −77.14° | −51.43° | −25.71° | 0° | 25.71° | 51.43° | 77.14° |
| 9 | 77.14° | 51.43° | 25.71° | 0° | −25.71° | −51.43° | −77.14° |
| 10 | 231.43° | 154.29° | 77.14° | 0° | −77.14° | −154.29° | −231.43° |
| 11 | 25.71° | 257.14° | 128.57° | 0° | −128.57° | −257.14° | −25.71° |
| 12 | 180° | 360° | 180° | 0° | −180° | −360° | −180° |
| 13 | 334.29° | 102.86° | 231.43° | 0° | −231.43° | −102.86° | −334.29° |
| 14 | 128.57° | 205.71° | 282.86° | 0° | −282.86° | −205.71° | −128.57° |
| 15 | 282.86° | 308.57° | 334.28° | 0° | −334.28° | −308.57° | −282.86° |
| 16 | 77.14° | 51.43° | 25.71° | 0° | −25.71° | −51.43° | −77.14° |

Recall that radiating elements #1, #8 and #15 share the same phase shifter and can be considered the first radiating elements in their respective subarrays. One can verify from Table I that the steering angles for radiating elements #1, #8 and #15 are substantially identical when the array is beamforming at the angle −58.99°, taking into account that the difference between the steering angle of #1 and #8)(−77.14° and that of #15 (282.86°) is 360°. One can also verify from Table I that the steering angles for radiating elements #1, #8 and #15 are also substantially identical when the array is beamforming at the other switching angles. A similar relationship holds for the radiating elements #2, #9 and #16, radiating elements #3 and #10, and so on.

In other words, a gain peak can be achieved at a particular θₛ because at that θₛ, the n^{th} radiating element in each subarray is radiating (and receiving) waves at substantially equal phases.

In some embodiments, each of the radiating elements 37 has a center 379, and the spacing between adjacent radiating elements is measured at the respective centers 379. In some embodiments, the center 379 may be the phase center of the radiating element 37.

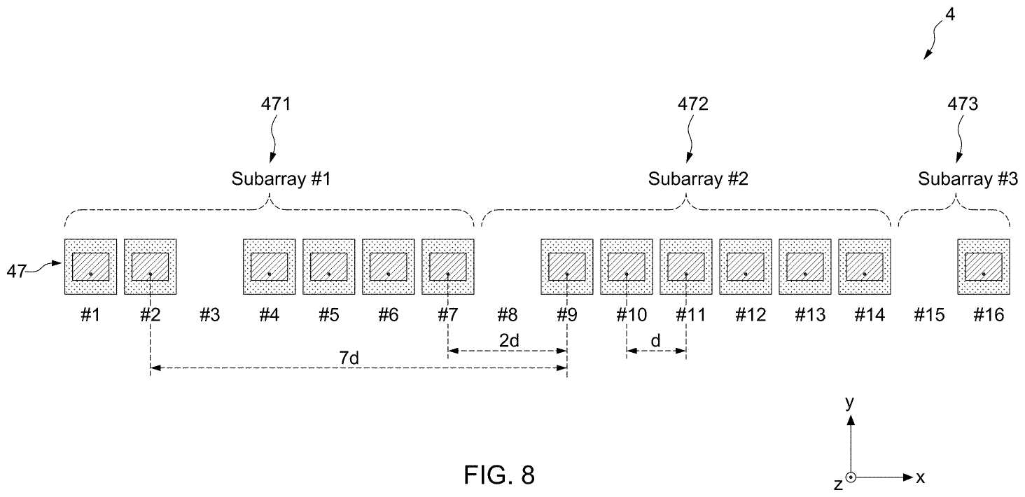

Refer to FIG. 8, which illustrates an antenna array 4 including N=13 microstrip patch antennas as the radiating elements 47. FIG. 8 may be viewed as another implementation of the subject matter of the present disclosure. For simplicity, only the radiating elements 47 of the antenna array 4 are illustrated in FIG. 8; other elements, such as phase shifters and power distribution networks, are not shown in FIG. 8.

The embodiment of FIG. 8 differs from that of FIG. 3 in several aspects. One of these aspects is that the radiating elements 47 are not uniformly distributed, as seen in the empty slots #3, #8 and #15, which were occupied by radiating elements 37 in the embodiment of FIG. 3. Hence, while many adjacent radiating elements are separated from each other by the distance d, other amounts of spacing are possible, such as 2d, between radiating elements #2 and #4, radiating elements #7 and #9, and radiating elements #14 and #16. In an embodiment, spacing amounts such as 3d and 4d are also possible by removing a sufficient number of radiating elements.

That said, the spacing amounts that are possible are not arbitrary. If the smallest spacing between two adjacent radiating elements is set to, for example, d, then other available spacing amounts are integer multiples of d. This should be easy to understand in view of equations (1) to (4) and the associated description about maintaining a property where radiating elements with specific spacing have substantially-equal phase.

In some embodiments, the “removal” of a radiating element does not necessarily mean physical absence from the array; rather, cutting off the signal feed to a radiating element would suffice to “remove” it from the array, because said radiating element would cease to transmit or receive waves that may interfere with other radiating elements.

The antenna array 4 in FIG. 8 has fewer radiating elements than the antenna array 3 in FIG. 3. However, the phase relationship as described in equations (1) to (4) is still applicable. That is, in the embodiment of FIG. 8, the first phase shifter may be connected to radiating element #1; the second phase shifter may be connected to radiating elements #2, #9 and #16; the third phase shifter may be connected to radiating element #10, and so on. Based on equations (2)-(4), the solutions for θₛ still exist at ±58.99°, ±34.85°, ±16.60°, and 0°.

A variant to the embodiment of FIG. 8 is that radiating element #9 is also removed. In that case, the second phase shifter is connected to radiating elements #2 and #16; as such, radiating elements #2 and #16 may also be referred to as “sequential” radiating elements.

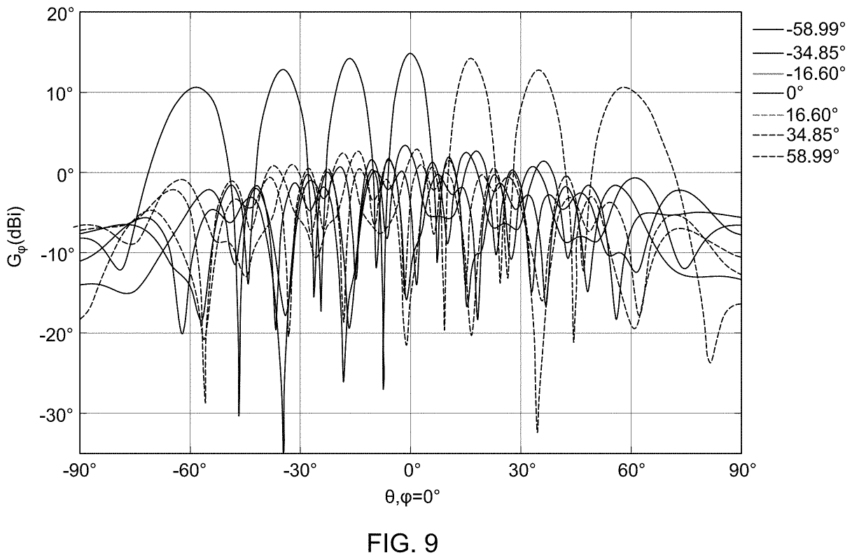

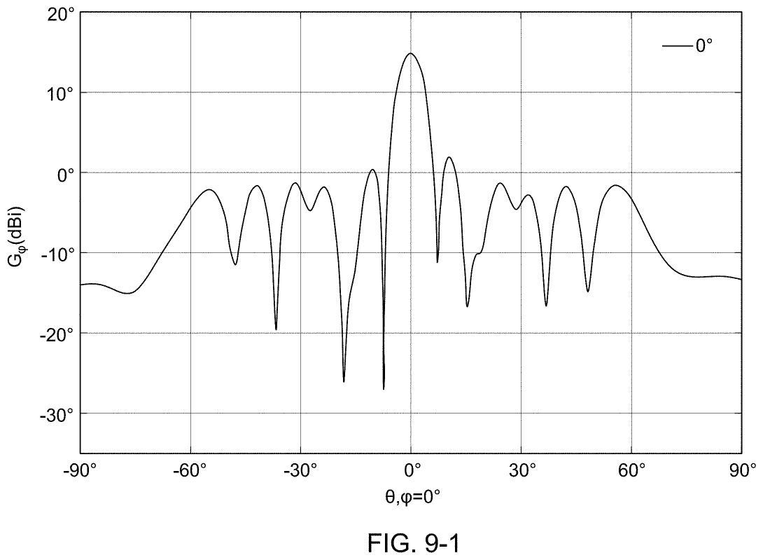

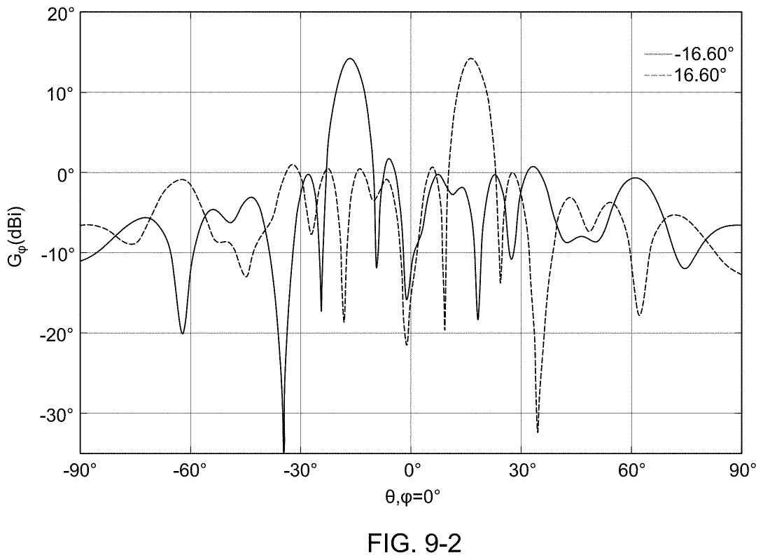

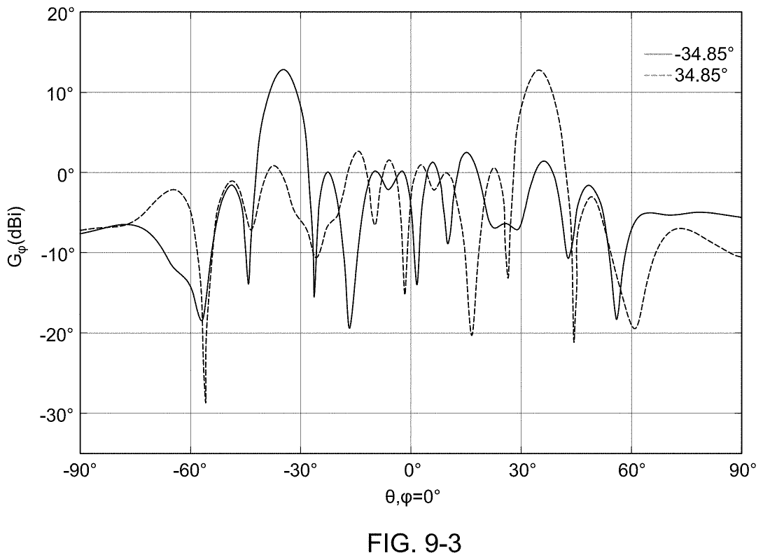

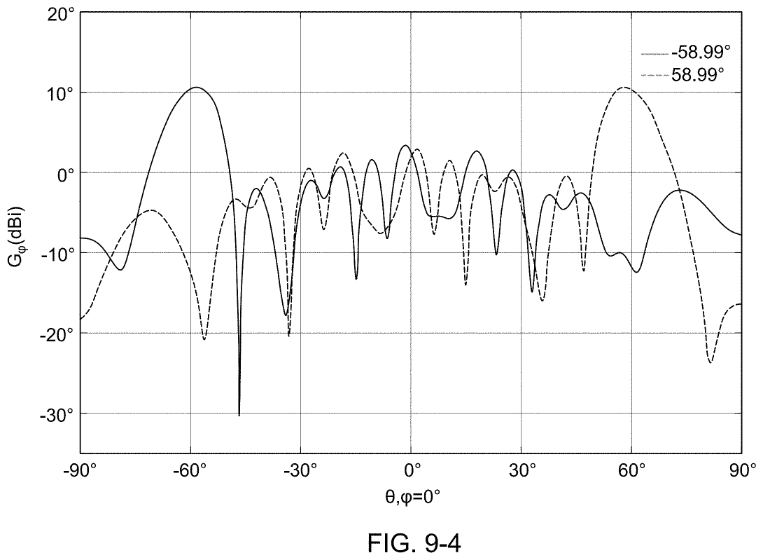

FIG. 9 illustrates exemplary radiation patterns at the seven solutions for θₛ, according to an embodiment of the present disclosure. Also, FIGS. 9-1 to 9-4 illustrate the exemplary radiation patterns at the solutions of 0°, ±16.60°, ±34.85° and ±58.99°, respectively. Similar to FIG. 7, FIG. 9 also demonstrates that peak gains can be achieved at the seven solutions for θₛ. The difference is that, because of fewer radiating elements, the maximum gain in FIG. 9 is slightly less than that in FIG. 7.

The embodiment of FIG. 8 demonstrates another benefit of the subject matter of the present disclosure: flexibility in choosing the number and location of the radiating elements. Particularly, uniform distribution is merely an option, not an absolute requirement. Phased array system designers utilizing the subject matter of the present disclosure may better accommodate various design requirements, such as cost and form factor, while enjoying the beamforming benefits at specific switching angles that can be easily computed.

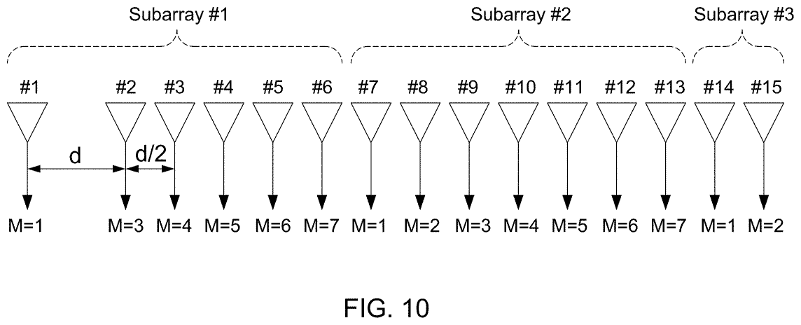

FIG. 10 illustrates an exemplary configuration of a phased array, in accordance with some embodiments of the present disclosure. In this exemplary configuration, the number of radiating elements N is 15, the number of phase shifters M is 7, and the minimum spacing between two adjacent radiating elements is d/2. According to the above teaching of the present disclosure, the first phase shifter (“M=1” in FIG. 10) is connected to the first radiating element in each of the three subarrays. The second phase shifter (“M=2” in FIG. 10) is connected to the second radiating element in the second and third subarrays, but not to the second radiating element of the first subarray, due to the wider spacing between the first two radiating elements in the first subarray.

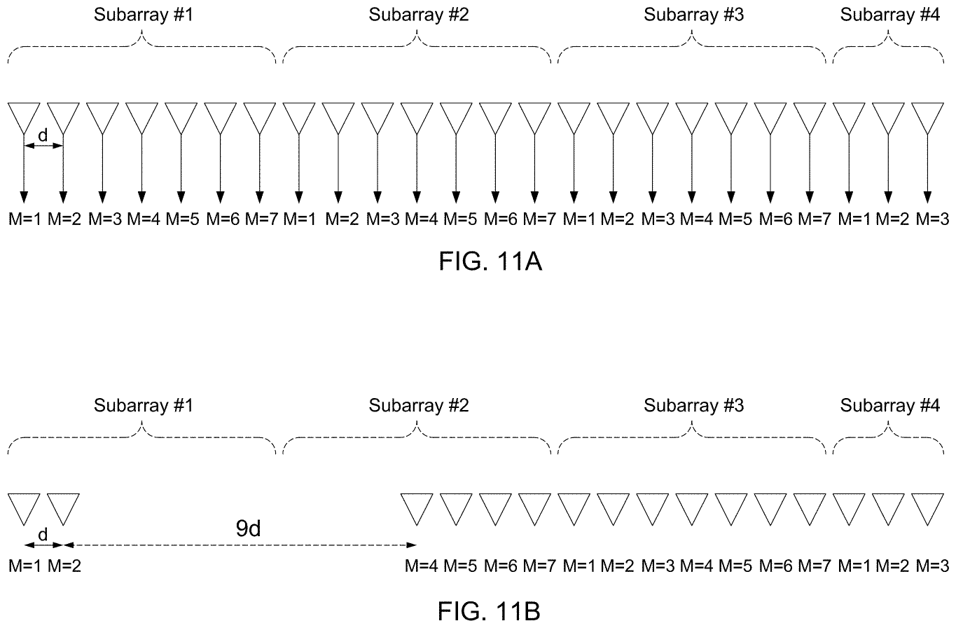

FIG. 11A illustrates an exemplary configuration of a phased array, in accordance with some embodiments of the present disclosure. In this exemplary configuration, the number of radiating elements N is 24, the number of phase shifters M is 7, and the minimum spacing between two adjacent radiating elements is d. The 24 radiating elements are uniformly spaced and grouped into four subarrays, in which the first three subarrays contain M=7 radiating elements, and the last subarray contains 3 (the remainder of 24 divided by 7) radiating elements.

FIG. 11B illustrates an exemplary configuration of a phased array, in accordance with some embodiments of the present disclosure. In this exemplary configuration, the number of radiating elements N is 16, the number of phase shifters M is 7, and the minimum spacing between two adjacent radiating elements is d. The 16 radiating elements are grouped into four subarrays without being uniformly spaced. The first three subarrays have different numbers of radiating elements; however, these three subarrays may still be regarded as having substantially the same size in the sense that each of them can have at most 7 (M) radiating elements. The spacing between the two radiating elements in the first subarray is d, as is the spacing between adjacent radiating elements in the second subarray. Also, the spacing between the last radiating element of the first subarray and the first radiating element of the second subarray, 9d, is still an integer multiple of d.

In the present disclosure, a phrase “one of A, B and C” means “A, B and/or C” (A, B, C, A and B, A and C, B and C, or A, B and C), and does not mean one element from A, one element from B and one element from C, unless otherwise described.

In the present disclosure, expressions such as “about” and “approximately,” which precede a value, indicate that the value is exactly as described or within a certain range of the value as described, while taking into account the design error/margin, manufacturing error/margin, measurement error, etc. Such a description should be recognizable to one of ordinary skill in the art.

Any of the embodiments described herein may be used alone or together in any combination. The one or more implementations encompassed within this specification may also include embodiments that are only partially mentioned or alluded to or not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

Further, it will be understood that when an element is referred to as being “connected to” or “coupled to” another element, it may be directly connected to or coupled to the other element, or intervening elements may be present.

In the present disclosure, when expressions such as “substantially similar,” “substantially identical” and “substantially equal” describe two phase values, these expressions mean that the two phase values are sufficiently close to each other so that two signals with these two phase values can produce constructive interference. It is well known that two signals with a phase difference that is less than about 22.5 degrees can produce constructive interference. A phase difference that is less than about 15 degrees can produce more constructive interference. Phase differences that are less than about 15 degrees, or about 10 degrees, or about 5 degrees, or about 2 degrees, or about 1 degree can all produce constructive interference.

It will be understood that not all advantages have been necessarily discussed herein, that no particular advantage is required for all embodiments or examples, and that other embodiments or examples may offer different advantages.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A radiation-processing array, comprising:
N radiating elements, wherein N is an integer greater than or equal to three, wherein the N radiating elements are arranged linearly and are substantially equally spaced; and
M phase shifters, wherein M is an integer greater than or equal to two and less than N;
wherein the N radiating elements are divided into a first plurality of groups of adjacent radiating elements, wherein all but one of the first plurality of groups comprise M radiating elements;
wherein each of the M phase shifters is connected to a respective radiating element in each of the groups such that a distance between two sequential radiating elements connected to the same phase shifter is substantially identical;
wherein each of the N radiating elements is connected to at most one phase shifter.

2. The radiation-processing array of claim 1, wherein all of the first plurality of groups comprise M radiating elements.

3. The radiation-processing array of claim 1, wherein the one group that does not comprise M radiating elements is arranged after the other groups and comprises fewer than M radiating elements.

4. The radiation-processing array of claim 1, wherein the radiating elements comprise either electromagnetic-wave radiating elements or mechanical-wave radiating elements.

5. The radiation-processing array of claim 1, wherein the radiating elements comprise an antenna or a sonar device.

6. The radiation-processing array of claim 1, wherein each of the N radiating elements comprises a phase center, and wherein the phase centers of the N radiating elements form a substantially straight line.

7. The radiation-processing array of claim 6, wherein a distance between the phase centers of two adjacent radiating elements is substantially identical for all adjacent radiating elements.

8. An antenna array, comprising:
N radiating elements, wherein N is an integer greater than or equal to three, wherein the N radiating elements are arranged linearly, wherein two adjacent radiating elements are separated substantially by an integer multiple of a first spacing;
M phase shifters, wherein M is an integer greater than or equal to two and less than N;
wherein the N radiating elements are grouped into a first number of groups, wherein each of the groups comprises at least one and at most M adjacent radiating elements;
wherein the N radiating elements are connected to the M phase shifters in such a way that:
one radiating element is connected to at most one phase shifter;
two sequential radiating elements connected to the same phase shifter are separated by a second spacing, the second spacing being substantially an integer multiple of M multiplied by the first spacing.

9. The antenna array of claim 8, wherein the first number is the ceiling function of N divided by M.

10. The antenna array of claim 8, wherein a beamforming angle of the antenna array satisfies the equation of
$$- 1 \leq \frac{ξ \cdot π}{β \cdot M \cdot d \cdot {180}^{°}} = sin {θ}_{s} \leq 1 ,$$
where ξ is an integer multiplied by 360 degrees, d is the first spacing, and β is the phase constant of the medium in which radiation to or from the antenna array propagates.

11. The antenna array of claim 8, wherein a path length from at least one radiating element to a respective phase shifter is substantially identical to or is substantially an integer multiple of a wavelength at an operating frequency.

12. The antenna array of claim 11, wherein, for each of the N radiating elements, the path length from the radiating element to the respective phase shifter is substantially identical to or is substantially an integer multiple of the wavelength at the operating frequency.

13. A mobile communication device comprising an antenna array of claim 8.

14. A base station comprising an antenna array of claim 8.

15. An antenna array, comprising:
at least three linearly arranged radiating elements;
at least two phase shifters, where a number of the phase shifters is fewer than a number of the radiating elements; and
at least two dividers, wherein a number of the dividers is the same as the number of the phase shifters, wherein each of the dividers comprises an input port and a plurality of output ports;
wherein each of the phase shifters is connected to the input port of a respective divider;
wherein the radiating elements are divided into a plurality of groups of adjacent radiating elements, wherein each group comprises at most the same number of radiating elements as the number of the phase shifters;
wherein the output ports of each of the dividers is connected to at most one respective radiating element in each of the groups in such a way that for each of the radiating elements connected to the same divider, substantially similar phase progressions occur between an output of the phase shifter and the radiating elements.

16. The antenna array of claim 15, wherein a magnitude of a difference between the phase progressions that occur between the output of the phase shifter and each of the radiating elements connected to the same divider is less than 22.5 degrees.

17. The antenna array of claim 16, wherein the magnitude of the difference between the phase progressions that occur between the output of the phase shifter and each of the radiating elements connected to the same divider is less than 15 degrees, or 10 degrees, or 5 degrees, or 2 degrees, or 1 degree.

18. A method for operating a wave-generation array, wherein the wave-generation array comprises a first plurality of linearly arranged radiating elements and a second plurality less than the first plurality of phase shifters, wherein the first plurality is at least three and the second plurality is at least two, the method comprising:
arranging the first plurality of radiating elements into a third plurality of groups of neighboring radiating elements; and
connecting each of the second plurality of phase shifters to at most one radiating element in each group, such that a steering phase of a radiating element is substantially identical to the steering phase of other radiating elements connected to the same phase shifter.

19. The method of claim 18, wherein a magnitude of a difference between the steering phase of the radiating elements connected to the same phase shifter is less than 22.5 degrees, or 15 degrees, or 10 degrees, or 5 degrees, or 2 degrees, or 1 degree.

20. The method of claim 19, wherein the magnitude of the difference between the steering phase of the radiating elements connected to the same phase shifter is less than 15 degrees, or 10 degrees, or 5 degrees, or 2 degrees, or 1 degree.

21. The method of claim 18, further comprising:
pointing the wave-generation array at a switching angle θₛ, wherein θₛ satisfies the equation of
$$- 1 \leq \frac{ξ \cdot π}{β \cdot M \cdot d \cdot {180}^{°}} = sin {θ}_{s} \leq 1 ,$$
where ξ is an integer multiplied by 360 degrees, β is the phase constant of free space, and M is the second plurality.
